(19) United States
(12) Patent Application Publication
(10) Pub. No.: US 2014/0039109 A1
(43) Pub. Date: Feb. 6, 2014

(54) TREATED INORGANIC PIGMENTS HAVING IMPROVED BULK FLOW AND THEIR USE IN COATING COMPOSITIONS

(71) Applicant: Daniel C. Kraiter, Wilmington, DE (US)

(72) Inventor: Daniel C. Kraiter, Wilmington, DE (US)

(73) Assignee: E. I. Du Pont de Nemours and Company, Wilmington, DE (US)

(21) Appl. No.: 14/112,959

(22) PCT Filed: Apr. 24, 2012
(86) PCT No.: PCT/US12/34750

§ 371 Date: Oct. 21, 2013

Related U.S. Application Data
(60) Provisional application No. 61/480,088, filed on Apr. 28, 2011.

(51) Int. Cl. C09D 7/12

(52) U.S. Cl. CPC C09D 7/1225
USPC 524/388; 106/499; 524/386; 106/447; 106/483

(57) ABSTRACT

The disclosure provides a coating composition comprising a treated inorganic pigment, wherein the treated inorganic pigment comprises an inorganic pigment comprising a pigment surface area of about 30 to about 75 m²/g; wherein the pigment surface is treated with an organic treating agent comprising a polyalkanol alkane or a polyalkanol amine, present in the amount of at least about 1.5%, and wherein the treated inorganic pigment has a RHI (rat hole index) of about 7 to about 11.

### BACKGROUND OF THE DISCLOSURE

1. Field of the Disclosure

The present disclosure relates to treated inorganic pigments, more particularly treated titanium dioxide, having an improved bulk flow; a process for their preparation; and their use in coating compositions.

2. Description of the Related Art

Coating compositions of interest in the present disclosure are water-dispersible coating compositions such as latex coating compositions, e.g. acrylic, styrene acrylic, vinyl acetate, ethylene vinyl acetate, polyurethane, alkyd dispersion etc; and solvent based such as alkyd coating compositions; urethane coating compositions; and unsaturated polyester coating compositions, acrylic, styrene-acrylic compositions typically a paint, clear coating, or stain. These coatings may be applied to a substrate by spraying, applying with a brush or roller or electrostatically, such as pigment coatings, etc. These coating compositions are described in Outlines of Paint Technology (Halstead Press, New York, N.Y., Third edition, 1990) and Surface Coatings Vol. I, Raw Materials and Their Usage (Chapman and Hall, New York, N.Y., Second Edition, 1984).

Inorganic pigments may be added to the coating compositions. In particular, titanium dioxide pigments have been added to coating compositions for imparting whiteness and/or opacity to the finished article. However, the flat grade pigments used in some coating compositions have had lower bulk density and are difficult to handle This reduces the productivity of coating manufacturing facilities.

A need exists for an inorganic pigment such as titanium dioxide that has greater bulk density, improved flow characteristics and that is easier to handle in use.

### SUMMARY OF THE DISCLOSURE

In a first aspect, the disclosure provides a coating composition comprising a treated inorganic pigment, wherein the treated inorganic pigment comprises an inorganic pigment, and in particular a titanium dioxide pigment, wherein the inorganic pigment, and in particular a titanium dioxide pigment, comprises a pigment surface area of about 30 to about 75 m²/g; more typically about 40 to about 70 m²/g; and still more typically about 45 to about 65 m²/g, and still more typically about 50 to about 60 m²/g wherein the pigment surface is treated with an organic treating agent comprising a polyalkanol alkane or a polyalkanol amine, present in the amount of at least about 1.5%, more typically at least about 1.8% and still more typically at least about 2%; wherein the treated inorganic pigment, and in particular titanium dioxide pigment, has a RHI (rat hole index) of about 7 to about 11, more typically about 7 to about 10, and still more typically about 7 to about 9.

### BRIEF DESCRIPTION OF THE DRAWINGS

FIG. 1 is a flow function graph that depicts the cohesive strength (fc) developed in response to compaction stress (Sigma1)

### DETAILED DESCRIPTION OF THE DISCLOSURE

The disclosure relates to a process for treating an inorganic pigment, typically a titanium dioxide pigment, to form a pigment capable of being dispersed into a polymer melt, a paper slurry or a coating composition that can be used as a paint or an ink. The organic treatment in the treated pigment may be present in the amount of at least about 1.5 weight % more typically in the amount of at least about 1.8 weight %, and most typically in the amount of at least about 2 weight %, based on the total weight of the treated pigment. Further, these treated pigments demonstrate improved flow characteristics, generally fewer lumps, and have a RHI, rat hole index, of about 7 to about 11, more typically about 7 to about 10, and still more typically about 7 to about 9.

### Treated Pigment:

It is contemplated that any inorganic pigment will benefit from the surface treatment of this disclosure. By inorganic pigment it is meant an inorganic particulate material that becomes uniformly dispersed throughout a polymer melt, a paper slurry, or coating resin and imparts color and opacity to the polymer melt, paper slurry, or coating resin. Some examples of inorganic pigments include but are not limited to ZnS, TiO₂, CaCO₃, BaSO₄, ZnO, MoS₂, silica, talc or clay.

In particular, titanium dioxide is an especially useful pigment in the processes and products of this disclosure. Titanium dioxide (TiO₂) pigment useful in the present disclosure may be in the rutile or anatase crystalline form. It is commonly made by either a chloride process or a sulfate process. In the chloride process, TiCl₄ is oxidized to TiO₂ pigments. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The pigment may be a pigment or nanoparticle.

By “pigment” it is meant that the titanium dioxide pigments have an average size of less than 1 micron. Typically, the pigments have an average size of from about 0.020 to about 0.95 microns, more typically, about 0.050 to about 0.75 microns and most typically about 0.075 to about 0.60 microns, as measured by Horiba LA300 Particle Size Analyzer

The titanium dioxide pigment may be substantially pure titanium dioxide or may contain other metal oxides, such as silica, alumina, zirconia. Other metal oxides may become incorporated into the pigments, for example, by co-oxidizing or co-precipitating titanium compounds with other metal compounds. If co-oxidized or co-precipitated up to about 20 wt % of the other metal oxide, more typically, 0.5 to 5 wt %, most typically about 0.5 to about 1.5 wt % may be present, based on the total pigment weight.

The titanium dioxide pigment may also bear one or more metal oxide surface treatments. These treatments may be applied using techniques known by those skilled in the art. Examples of metal oxide treatments include silica, alumina, and zirconia among others. Such treatments may be present in an amount of about 0.1 to about 20 wt %, based on the total weight of the pigment, typically about 0.5 to about 12 wt %, more typically about 0.5 to about 3 wt %.

The inorganic pigment may have a surface area of about 30 to about 75 m²/g; more typically about 40 to about 70 m²/g; and still more typically about 45 to about 65 m²/g, and still more typically about 50 to about 60 m²/g.

The pigments of this disclosure may be treated with organic surface treatments such as a polyalkanol alkane or a polyalkanol amine. Some examples of polyalkanol alkanes include trimethylol-propane, trimethylolethane, glycerol, ethylene glycol, propylene glycol, 1,3 propanediol, pentaerythritol, etc. Some examples of polyalkanol amine include 2-amino-2methyl-1-propanol, triethanol amine, monoethanol amine, diethanol amine, 1-amino 2-propanol, or 2-amino ethanol. The organic surface treatment are present in the amounts of at least about 1.5 weight %, more typically in the amount of at least about 1.8 weight %, and most typically in the amount of at least about 2 weight %, based on the total weight of the treated pigment. Amounts of organic surface treatment that are more than 10% may cause excessive dusting, color change and unnecessary dilution of the TiO₂.

Optionally, hydrous oxides are precipitated onto the base TiO₂ particles or TiO₂ particles that have been coated with inorganic particles. Such hydrous oxides are silica, alumina, zirconia, or the like. These may be added either before or after the addition of inorganic particles. If the hydrous oxides are added prior to addition of inorganic particles, then a filtering and washing step may be used prior to the addition of inorganic particles for colloidal suspensions that may be sensitive to flocculation. It is typical that the inorganic particles are added before the hydrous oxides are precipitated to further anchor the inorganic particles to the TiO₂ surface. For example, the method for precipitating the hydrous oxide is described in U.S. Pat. No. Re 27,818 and U.S. Pat. No. 4,125,412, the teachings of which are incorporated herein by reference. In precipitating the hydrous oxides, sodium silicate is added and neutralized with an acid such as HCl, H₂SO₄, HNO₃, H₃PO₄ or the like and then sodium aluminate is added and neutralized with add. Other means of precipitated hydrous alumina are suitable, such as neutralization of aluminum sulfate or aluminum chloride using a base such as NaOH. The amount of hydrous oxide can vary from about 0 to about 16%, based on the total weight of the coated TiO₂ pigment. Typical amounts are about 0 to about 8 wt. % silica, more typically about 0 to about 4 wt. % silica, and about 0 to about 8 wt. % alumina, more typically about 0 to about 3 wt. % alumina. The order of addition is not particularly critical, however the hydrous alumina precipitation, if added, is the last preferred addition. The conventional finishing steps such as filtering, washing, drying and grinding are known and are subsequently carried out. The resulting product is dry, finished pigment that is useful for end use applications and/or can be used to prepare a slurry that is useful for end use applications.

After the inorganic wet treatment, the pigment is washed and filtered to remove salts. The process is done in a rotary filter or a filter press. The filter cake is then dried in a spray or flash drier and the drier discharge is de-agglomerated in a hammermill. The pigment is conveyed pneumatically to a fluid energy mill, e.g. micronizer where the final de-agglomeration step is done. The organic treatment can be done by spraying alkanol alkane or alkanol amine (neat or as an aqueous solution) at several locations: onto the filtercake before the hammermill, at the micronizer (main inlet, jet nozzle and/or main outlet). The addition can take place exclusively at one location or at more than one location, simultaneously.

### Properties of the Treated TiO2 Article

While pigments are ultimately utilized for their ability to provide color or opacity to coatings or manufactured goods such as paper or plastic parts, the bulk handling properties of dry pigment prior to incorporation in a process are important.

The loose bulk density determines the size of package necessary to contain a specified mass of pigment, and pigments with excessively low bulk densities may not fill shipping containers (such as trucks) to their specified weight limits, resulting in increased transportation costs. At the consuming site, low bulk density pigments require larger storage vessels for the same mass, increasing capital costs. Screw feeders are commonly used in pigment processing, and their throughput is determined by pigment density. An existing feeder appropriate for one pigment may not be able to feed a second pigment with excessively low bulk density at the required rate. Certain processes for the incorporation of pigment into highly loaded polymer systems (master batching) utilize extruders or batch mixers (such as Banbury mixers) whose throughput capacity is limited by the volumetric displacement of the machine. A pigment with low bulk density does not fill such machines effectively, resulting in a reduction of pigment processing capacity.

The resistance of a dry pigment to flow by gravity will determine the type of equipment (silos, conveyors, and feeders) necessary for reliable storage and retrieval. Pigments with exceptionally poor flow properties may cause blockages in silos and handling systems intended for better-flowing powders. A pigment with superior flow properties can be expected to flow more reliably through existing equipment, and can reduce the investment necessary for new equipment by limiting the need for special features to promote flow. The accuracy of pigment dispensing (dosing) by loss-in-weight feeders will be enhanced by improved flowability, since the pigment will flow more uniformly through the equipment. Similarly, some mixing processes take place more readily if the pigment is readily dispersed (i.e, has little cohesion) when mixed amongst other ingredients.

Flowability in practice is determined by the quotient of pigment cohesive strength, which binds the particles together and impedes flow, and bulk density, which promotes flow under gravitational forces. The properties of cohesive strength and compacted bulk density must be measured under appropriate loading conditions. Using silo design theory (see Powders and Bulk Solids: Behavior, Characterization, Storage and Flow, by Dietmar Schulze, 2007 (English version), Springer, ISBN 9783-54073767-4) the silo outlet size necessary for reliable discharge by gravity can be calculated. This outlet size could be that required to prevent bridging (aka arching or doming) or ratholing (aka piping). Due to the nature of the flow patterns that are encountered in pigment handling, ratholing problems are dominant, so methods to predict the required size of outlet to prevent ratholing are most useful. Ratholing propensity otherwise known as rathole index (RH) can be measured directly with the Johanson Hang-Up Indicizer (Johanson Innovations, San Luis Obispo, Calif.). The treated inorganic pigment, and in particular titanium dioxide pigment, has a RHI (rat hole index) of about 7 to about 11, more typically about 7 to about 10, and still more typically about 7 to about 9. Ratholing propensity can also be calculated from cohesive strength measurements made with shear cell devices such as the Jenike Shear Cell or the Schulze Ring Shear tester (both available from Jenike and Johanson, Inc, Tyngsboro, Mass.).

The treatment of the inorganic pigment of this disclosure not only helps the processability of solid particulates by lowering the particle surface energy, but also can increase bulk density, which is beneficial to pigment handling and packing. The level of organic treatment in order to achieve substantially uniform coverage of at least a monolayer around each pigment particle must be proportional to the pigment surface area. The higher the surface area, the higher the demand for the organic treatment is.

The RHI for the treated pigment of this disclosure is notably low. The bulk density is slightly higher than the untreated pigment. The RHI is proportional to the quotient of the cohesive strength divided by the bulk density, with both strength and density measured under specified levels of compaction stress:

$$RHI = \frac{cohesive strength}{bulk density} \times constant$$

Since for the treated pigment of this disclosure the RHI is lower, and bulk density is only slightly greater than the corresponding quantities for the untreated pigment, the cohesive strength must be significantly low. Measurement of the cohesive strength independent of the RHI measurement, showed an important difference between the treated pigment of this disclosure and the standard (untreated) pigment. Powders with low values of cohesive strength are often easier to feed accurately with screw feeders and also easier to mix in the dry state with other powders.

### Coating Compositions:

This disclosure is particularly suitable for producing coating compositions, and in particular architectural paint formulations or ink formulations.

Coating compositions prepared from colorant and the treated inorganic pigment, particularly treated TiO₂ pigment containing coating bases have improved paint or ink performance.

### Coating Base:

The coating base comprises a dispersion of resin and colorants of this disclosure. Other additives known to one skilled in the art may also be present.

### Resin:

The resin is selected from the group consisting of water-dispersible coating compositions such as latex coating compositions; alkyd coating compositions; urethane coating compositions; and unsaturated polyester coating compositions; and mixture thereof. By “water-dispersible coatings” as used herein is meant surface coatings intended for the decoration or protection of a substrate, comprising essentially an emulsion, latex, or a suspension of a film-forming material dispersed in an aqueous phase, and typically comprising surfactants, protective colloids and thickeners, pigments and extender pigments, preservatives, fungicides, freeze-thaw stabilizers, antifoam agents, agents to control pH, coalescing aids, and other ingredients. Water-dispersed coatings are exemplified by, but not limited to, pigmented coatings such as latex paints. For latex paints the film forming material is a latex polymer of acrylic, styrene-acrylic, vinyl-acrylic, ethylene-vinyl acetate, vinyl acetate, alkyd, vinyl chloride, styrene-butadiene, vinyl versatate, vinyl acetate-maleate, or a mixture thereof. Such water-dispersed coating compositions are described by C. R. Martens in “Emulsion and Water-Soluble Paints and Coatings” (Reinhold Publishing Corporation, New York, N.Y., 1965). Tex-Cote® and Super-Cote®, Rhopelx®, Vinnapase® EF500 are further examples of water based coating compositions comprising 100% acrylic resin.

The alkyd resins may be complex branched and cross-linked polyesters having unsaturated aliphatic acid residues. Urethane resins typically comprise the reaction product of a polyisocyanate, usually toluene diisocyanate, and a polyhydric alcohol ester of drying oil acids.

The resin is present in the amount of about 5 to about 40% by weight based on the total weight of the coating composition. The amount of resin is varied depending on the amount of sheen finish desired.

### Colorant:

The treated inorganic pigments, particularly the treated titanium dioxide pigments described earlier may be used alone or in combination with conventional colorants. Any conventional colorant such as a pigment, dye or a dispersed dye may be used in this disclosure to impart color to the coating composition. In one embodiment, generally, about 0.1% to about 40% by weight of conventional pigments, based on the total weight of the component solids, can be added. More typically, about 0.1% to about 25% by weight of conventional pigments, based on the total weight of component solids, can be added.

The pigment component of this disclosure may be any of the generally well-known pigments or mixtures thereof used in coating formulations, as reported, e.g., in Pigment Handbook, T. C. Patton, Ed., Wiley-Interscience, New York, 1973. Any of the conventional pigments used in coating compositions can be utilized in these compositions such as the following: metallic oxides, such as titanium dioxide, zinc oxide, and iron oxide, metal hydroxide, metal flakes, such as aluminum flake, chromates, such as lead chromate, sulfides, sulfates, carbonates, carbon black, silica, talc, china clay, phthalocyanine blues and greens, organo reds, organo maroons, pearlescent pigments and other organic pigments and dyes. If desired chromate-free pigments, such as barium metaborate, zinc phosphate, aluminum triphosphate and mixtures thereof, can also be used.

### Other Additives

A wide variety of additives may be present in the coating compositions of this disclosure as necessary, desirable or conventional. These compositions can further comprise various conventional paint additives, such as dispersing aids, anti-settling aids, wetting aids, thickening agents, extenders, plasticizers, stabilizers, light stabilizers, antifoams, defoamers, catalysts, texture-improving agents and/or antiflocculating agents. Conventional paint additives are well known and are described, for example, in “C-209 Additives for Paints” by George Innes, February 1998, the disclosure of which is incorporated herein by reference. The amounts of such additives are routinely optimized by the ordinary skilled artisan so as to achieve desired properties in the wall paint, such as thickness, texture, handling, and fluidity.

Coating compositions of the present disclosure may comprise various rheology modifiers or rheology additives (such as Acrysol®), wetting agents, dispersants and/or co-dispersants, and microbicides and/or fungicides. To achieve enhanced weatherability, the present coating compositions may further comprise UV (ultra-violet) absorbers such as Tinuvin®.

Coating compositions of the present disclosure may further comprise ceramic or elastomeric substances, which are heat and/or infrared reflective, so as to provide additional heat reflective benefits.

### Preparation of the Coating Composition and its Use:

The present disclosure provides a process for preparing a coating composition, such as a paint formulation, comprising mixing the pigment-containing components with the resin to form a coating base. Optionally a vehicle may be present. The vehicle may be aqueous or solvent based. Typically these coating compositions may comprise from about 30 to about 55% solids by weight and typically about 25% to about 45% solids by volume. Typically the coating compositions of this disclosure have a density of about 9.1 to about 11.9 pounds per gallon, more typically about 9.5 to about 10.8 pounds per gallon. Any mixing means known to one skilled in the art may be used to accomplish this mixing. An example of a mixing device includes a high speed Dispermat®, supplied by BYK-Gardner, Columbia, Md.

Coating compositions of the present disclosure may be applied by any means known to one skilled in the art, for example, by brush, roller, commercial grade airless sprayers, or electrostatically in a particle coating. Coating compositions presented herein may be applied as many times necessary so as to achieve sufficient coating on the coated surface, for example, an exterior wall. Typically, these coating compositions may be applied from about 2 mils to about 10 mils wet film thickness, which is equivalent to from about 1 to about 5 dry mils film thickness.

Coating compositions presented herein may be applied directly to surfaces or applied after surfaces are first coated with primers as known to one skilled in the art.

The coating compositions of this disclosure may be a paint, and the paint may be applied to a surface selected from the group consisting of building material, automobile part, sporting good, tenting fabric, tarpaulin, geo membrane, stadium seating, lawn furniture and roofing material.

The examples which follow, description of illustrative and typical embodiments of the present disclosure are not intended to limit the scope of the disclosure. Various modifications, alternative constructions and equivalents may be employed without departing from the true spirit and scope of the appended claims. In one embodiment, the coating films may be substantially free of other conventional colorants and contain solely the treated titanium dioxide pigments of this disclosure.

### TEST METHODS

### Loose Bulk Density (BD) Measurement:

Loose bulk density (BD) was measured as the most loosely packed bulk density when a material was left to settle by gravity alone. The loose bulk density utilized in these examples was measured using a Gilson Company sieve pan having a volume of 150.58 cm³. The material was hand sieved through a 10 mesh sieve over the tared pan until overfilled. Excess product above the rim of the pan was then carefully removed using a large spatula blade at a 45° angle from horizontal, taking care not to jostle the contents of the pan. The pan was then weighed and the loose bulk density was then calculated by dividing the pigment weight in the pan by the volume of the pan. Each measurement was repeated 3 times and the average was reported.

### Rathole Index (RHI) Measurement:

Using a Johanson Hang-Up Indicizer (Indicizer) from Johanson Innovations, Inc, the measured parameter know as rathole index (RHI), describes the degree of difficulty that can be expected in handling dry pigment in gravity flow situations, such as bins, hoppers, and feeders. The Indicizer compresses a known mass of pigment in a closed cell until the compaction stress corresponds to that expected in a bin or silo 10′ in diameter. It then measures the volume of the compacted pigment and the force necessary to press a punch through the compacted pigment. From this data, the Indicizer's internal computer calculates the compacted bulk density and the stress necessary to shear the pigment at the specified compaction stress. From these parameters, the RHI index is generated. The RHI is a predictor of the size of bin outlet necessary to prevent ratholing, a typical flow obstruction occurring in pigment handling. Larger values of the RHI imply worse flow properties of the pigment. The units are linear, so that a pigment with a 50% higher RHI may require a 50% larger silo outlet in order to flow reliably by gravity.

### Cohesive Strength (Schulze Ring Shear) Test

The Schulze Ring Shear Tester, described in ASTM standard D 6773, is a device for measuring the resistance of a powder to shearing while it is confined under a specified level of compaction stress. It can also measure the volume and (and infer the bulk density) of the sample while conducting the test. Samples of pigment are loaded into a test cell, which is then weighed and placed in the tester. The computer controlled tester (Schulze RST-01-pc) then proceeds through a series of loadings and shearing actions to create a collection of shear data points. These points form a yield locus which is subsequently interpreted via Mohr circles to generate the unconfined yield strength (fc) corresponding to a particular level of compaction stress, known as the major principal stress. The unconfined yield strength is a descriptor of the ability of a compressed, cohesive powder to resist flow. Additional tests can be conducted under other stress levels to create additional yield loci, resulting in a graph (known as a flow function) of unconfined yield strength as a function of major principal stress. From such data, it is possible to compare the cohesiveness of two powders if they were to be subjected to prescribed loading conditions, or to compare their ratholing propensities.

### Surface Area Measurement

The pigment surface area was measured using the 5 point nitrogen BET method using Micrometrics Tristar* 3000 Gas Adsorption Instrument and a Vac-Prep sample drying unit (Micrometrics Instrument Corp., Norcross, Ga.).

### Carbon Content Measurement

Carbon analysis was performed on each dry particle sample using LECO CS 632 Analyzer (LECO Corp. St, Joseph, Mich.).

### EXAMPLES

### Example 1

A sample of rude TiO₂ was treated with 10.2% silica and 6.4% alumina according to procedure described above. The treated pigment was filtered, washed and dried and 1500 g were added to a clean and dry, aluminum foil lined, metal pan. A solution of 50 wt % trimethylol propane (TMP) in Ethyl Alcohol was sprayed onto the pigment from a small, clean spray bottle. In order to ensure that the pigment surface was covered as uniformly as possible the pigment mass was mixed and turned over with a dean and dry metal spoon. The TMP/Ethyl Alcohol solution addition was then repeated several times until a total of 60 grams of solution were added. The pan was placed in a ventilated hood and pigment was allowed to air dry for 48 hours. A V-cone blender was used to break up any chunks of the TMP treated pigment as follows: V-cone tumble+intensifier bar for 10 minutes followed by V-cone tumble only for 5 minutes.

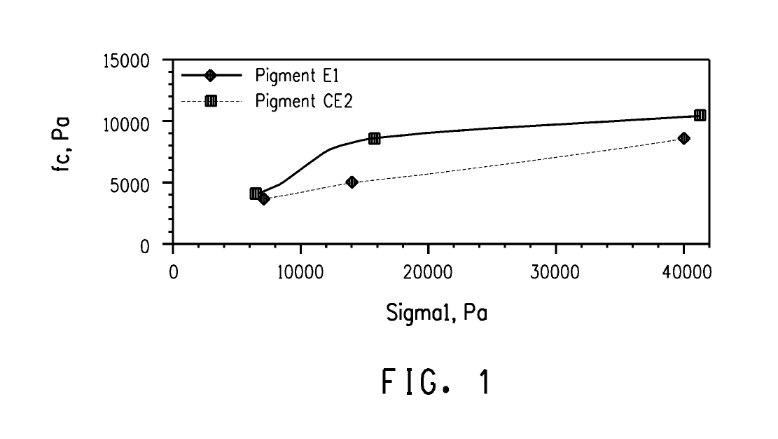

The sample was dry milled in a 8″ micronizer at a steam-to-pigment ratio (S/P) of 4 and a steam temp of 300° C. The product was tested for surface area, carbon content, rathole index, % residue on 10 mesh screen and bulk density with results shown in Table 1. The product was also tested for cohesive strength with results shown in FIG. 1.

### Example 2

Example 1 was repeated with the following exceptions: 2000 g of this pigment were added to a clean and dry, aluminum foil lined, metal pan instead of 1500 g and treated with a total of 40 grams of the TMP/Ethyl Alcohol solution instead of 60 grams. The product was tested for surface area, carbon content, rathole index, % residue on 10 mesh screen and bulk density with results shown in Table 1.

### Comparative Example 1

Example 2 was repeated with the following exceptions: No TMP/ethyl alcohol solution was added to the treated pigment and no drying, was therefore required. The product was tested for surface area, carbon content, rathole index, % residue on 10 mesh screen and bulk density with results shown in Table 1.

### Comparative Example 2

A sample of commercial rutile TiO₂ having the following oxide treatment 10.2% silica and 6.4% alumina and no organic treatment, was tested for surface area, Carbon content, rathole index, % residue on 10 mesh screen and bulk density. Results are shown in Table 1. The product was also tested for cohesive strength with results shown in FIG. 1.

### Example 3

Example 2 was repeated with the following exceptions: a total of 64 grams of TMP/ethyl alcohol solution were added. The product was tested for surface area, carbon content, rathole index, % residue on 10 mesh screen and bulk density with results shown in Table 1.

TABLE 1

| | | BET | RHI from | Screen on 10 | Loose Bulk |
|---|---|---|---|---|---|
| | % | Surface | Johanson | mesh, soft | Density |
| Sample | TMP* | Area(m²/g) | Indicizer** | lumps % | (g/cc) |
| E1 | 1.90 | 56.4 | 8.35 | 1.0 | 0.3686 |
| E2 | 0.94 | 52.9 | 8.59 | 1.0 | 0.4038 |
| CE1 | 0.0 | 56.39 | 12.20 | 1.3 | 0.3084 |
| CE2 | 0.0 | 54.99 | 12.88 | 1.4 | 0.4051 |
| E3 | 1.58 | 59.1 | 7.18 | 4.2 | 0.3899 |

*calculated from Carbon content
**average of two independent measurements

Samples E1, E2, and E3 show substantially improved (ie, reduced) values of RHI versus the comparative examples CE1 and CE2. The loose bulk densities produced by the examples generally equal or exceed those measured for the comparative examples. It should be noted that sample CE2 experienced minimal handling in the testing and could expected to retain some previous consolidation (packing) and densification associated with its prior handling. The proportion of the pigment that was soft lumps is not noteworthy for tests conducted at this scale.

A Schulze Ring Shear Tester was used to measure the cohesive strength of two samples of pigment, the first tested as described in this disclosure (E1 ) and the second without the additional treatment (CE2). Results are shown in FIG. 1. At all levels of consolidation stress (Sigma 1), the treated pigment exhibited lower values of unconfined yield strength, fc.

### Example 4

Pigment samples E1 and CE2 from Example 1 and Comparative Example 2, respectively, were incorporated in a paint formulation as shown in Table 2. These paints have similar low shear and high shear viscosities and similar pigment volume concentrations.

TABLE 2

| | |
|---|---|
| E1 | CE2 |

Add and grind at 4000 rpm, 15 min

| | | |
|---|---|---|
| Water | 228 | 230 |
| Tamol ® 1254 | 7.8 | 7.8 |
| Triton ® N-57 | 7 | 7 |
| Rhodoline ® 643 | 3 | 3 |
| Kathon ® LX 1.5% | 1.6 | 1.6 |
| TiO₂ (E1) | 136 | — |
| TiO₂ (CE 2) | — | 133.9 |
| Opacilite | 85 | 85 |
| Omyacarb ® UF | 152 | 152 |
| Imsil ®A-15 | 35 | 35 |

Add Letdown, mix at 1500 rpm for 10 min

| | | |
|---|---|---|
| ROVACE ® 9900 | 94 | 94 |
| Rhodoline ® 643 | 2 | 2 |
| Ammonia (28%) | 2.2 | 2.2 |
| Water | 246 | 248 |
| ACRYSOL ®DR-1 | 4 | 2 |
| ACRYSOL ® RM-7 | 8 | 12 |

Measured relative tinting strengths were 101 for E1 and 100 for CE2.

1. A coating composition comprising a treated inorganic pigment, wherein the treated inorganic pigment comprises an inorganic pigment comprising a pigment surface area of about 30 to about 75 m2/g; wherein the pigment surface is treated with an organic treating agent comprising a polyalkanol alkane or a polyalkanol amine, present in the amount of at least about 1.5%, and wherein the treated inorganic pigment has a RHI (rat hole index) of about 7 to about 11.

2. The coating composition of claim 1 further comprising a resin.

3. The coating composition of claim 2 wherein the resin is acrylic, styrene-acrylic, vinyl-acrylic, ethylene-vinyl acetate, vinyl acetate, alkyd, vinyl chloride, styrene-butadiene, vinyl versatate, vinyl acetate-maleate, or a mixture thereof.

4. The coating composition of claim 3 wherein the alkyd resin is a complex branched or cross-linked polyester having unsaturated aliphatic acid residues.

5. (canceled)

6. The coating composition of claim 2 wherein the resin is a urethane resin, and the urethane resin comprises the reaction product of a polyisocyanate and a polyhydric alcohol ester of drying oil acids.

7. (canceled)

8. The coating composition of claim 2 wherein the resin is present in the amount of about 5 to about 40 % by weight, based on the total weight of the coating composition.

9. The coating composition of claim 1 wherein the inorganic pigment is ZnS, TiO₂, CaCO₃, BaSO₄, ZnO, MoS₂, silica, talc or clay.

10. The coating composition of claim 9 wherein the inorganic pigment is titanium dioxide.

11. The coating composition of claim 1 wherein the pigment surface area is about 40 to about 70 m₂/g.

12. (canceled)

13. The coating composition of claim 1 wherein the organic treating agent is a polyalkanol alkane.

14. The coating composition of claim 13 wherein the polyalkanol alkane is trimethylolpropane, trimethylolethane, glycerol, ethylene glycol, propylene glycol, 1,3 propanediol, or pentaerythritol.

15. (canceled)

16. The coating composition of claim 1 wherein the organic treating agent is a polyalkanol amine.

17. The coating composition of claim 16 wherein the polyalkanol amine is 2-amino-2methyl-1-propanol, triethanol amine, monoethanol amine, diethanol amine, 1-amino 2-propanol, or 2-amino ethanol.

18. (canceled)

19. The coating composition of claim 1 wherein the organic treating agent is present in the amount of at least about 1.8%, based on the total weight of the treated pigment.

20. (canceled)

21. The coating composition of claim 1 further treated with metal oxides.

22. The coating composition of claim 21 wherein the metal oxide treatment comprises silica, alumina, tungsten, zirconia, zinc oxide, or molybdenum oxide.

23. The coating composition of claim 22 wherein the metal oxides are present in the amount of 0.1 to about 20 wt %, based on the total weight of the treated pigment.

24. The coating composition of claim 1 wherein the coating composition is a paint.

25. The coating composition of claim 24 wherein the paint is applied to a surface selected from the group consisting of building material, automobile part, sporting good, tenting fabric, tarpaulin, geo membrane, stadium seating, lawn furniture and roofing material.

26. A dried coating prepared from a coating composition comprising a treated inorganic pigment, wherein the treated inorganic pigment comprises an inorganic pigment comprising a pigment surface area of about 30 to about 75 m₂/g; wherein the pigment surface is treated with an organic treating agent comprising a polyalkanol alkane or a polyalkanol amine, present in the amount of at least about 1.5%, and wherein the treated inorganic pigment has a RHI (rat hole index) of about 7 to about 11.
